(19) United States
(12) Patent Application Publication
(10) Pub. No.: US 2013/0054126 A1
(43) Pub. Date: Feb. 28, 2013

(54) Two-Wheeled Vehicle

(71) Applicant: Massimo Lazzari, Genova (IT)

(72) Inventor: Massimo Lazzari, Genova (IT)

(21) Appl. No.: 13/696,526

(22) PCT Filed: May 5, 2011
(86) PCT No.: PCT/IT2011/000178

§ 371 Date: Nov. 6, 2012

(30) Foreign Application Priority Data
May 6, 2010 (IT) GE2010A000044

(51) Int. Cl. G05D 3/00

(52) U.S. Cl. 701/124

(57) ABSTRACT

Two-wheeled vehicle (4, 5), comprising: a cockpit (1) within which is provided at least one seat (3) for the driver and a command steering wheel (2); a gyroscopic system able to provide induced stability and self-balancing, even in static conditions, and including at least a couple of contrarotating gyrostats associated with operation means controlled by an electronic control unit; and a parking system (8) equipped with a pair of side wheels (9) having means (10) able to allow any possible lowering and lifting; such parking system (8) cooperates with the gyroscopic system under the control of the electronic control unit and is designed to act automatically, lowering these side wheels (9), in emergencies or in case of stopping, under static conditions, of such gyrostats.

This invention relates to a two-wheeled vehicle, the type of a motorcycle that, profitably, develops and abandons the potentially dangerous equestrian driving position in favor of a comfortable and secure cockpit, equal to that of a car, but with an external width of about 820 mm.

The vehicle in accordance with the invention uses exclusively targeted solutions, without approximate adjustments, to achieve the result of a vehicle that has in its accuracy of the design, the ability to ensure a new type of operation with very high levels of security and exploitation never before reached in a motorcycle, combined with the greatest ease of driving and use.

The subject of this invention is therefore a two-wheeled vehicle as claimed in claim 1.

If a motorcycle is by definition a means of dynamic stability, in this case, the stability also exists in stasis, in fact the control exercised to guide this vehicle since the initial instants, i.e. the start but before moving, is due not more to the legs of the driver but to a gyroscopic system of great power. This system is supported, once in movement, by the two main wheels of vehicle, which, advantageously, are both steering and to trail variable and contribute in synergy to dominate the forces that are generate by the proceeding vehicle but also in presence of unfavorable elements as the lateral wind, rain or whatever. The line has a fundamental importance for the characteristics of aerodynamics stability, for which the two main wheels are completely sport, in order to eliminate unfavorable aerodynamic effects. This vehicle can move with ease both forward and back, thanks both to the control of gyroscopic stability and to the adjustable and variable from positive to negative trail. The boxer bicylindrical engine of which is provided this vehicle has a particular design in order to be not invasive, to break down the vibrations, lower the centre of gravity and contribute to aerodynamics.

Even the front and rear suspension have the opportunity to absorb the more serious shocks that, together with the perfect weights distribution, will lead to exceptional results in strength tests.

Compared to other prototypes of “Gyrocars” known in the field, this vehicle has many advantages: the employed gyroscopes or gyrostats are two, coplanar, contrarotating; these features allow you to balance the reciprocal movement so as do not feel their presence; this will decrease the mass and the inertia in such a way to have positive effects in various situations dictated by the demands of driving.

It is crucial that these contrarotating masses can react quickly to any given order, both to steer and to stabilize (for example, to counter the wind in the wake of large trucks passing), relying on a gyroscopic effect that adapts instantly to the needs dictated by any type of situation encountered on the path, maintaining the essential stability and security.

Compared with “Gyrocars” prototypes known in the field this vehicle, using the gyro servo, has some unique features, as it is able to provide induced static stability, an induced self-balancing and an induced change in the angle of bending, in driving conditions and when cornering.

Additional features and advantages of the present invention will be better understood in the following description, given by way of example and without limitation, and refers to the accompanying drawings in which:

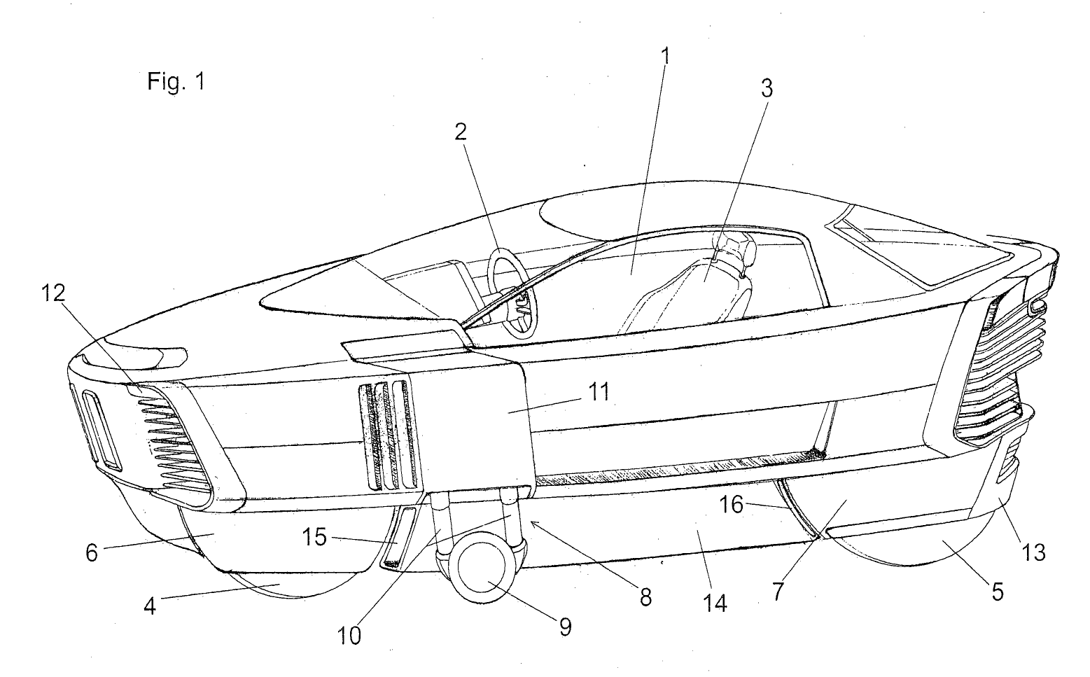

FIG. 1 illustrates a first perspective view of a two-wheeled vehicle in accordance with the present invention provided with a parking system equipped with side wheels vertically extensible and opening as a book, of which in figure only a lowered position is shown;

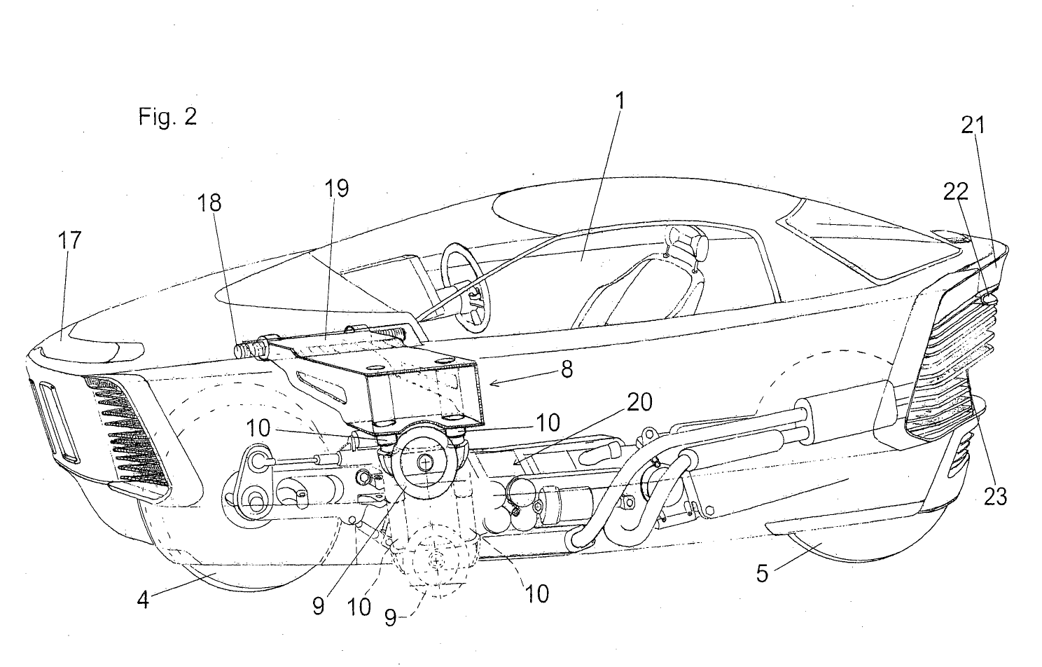

FIG. 2 illustrates a second perspective view, partially in section of this vehicle, which shows a mid-station system with its wheel in two positions, lowered and raised;

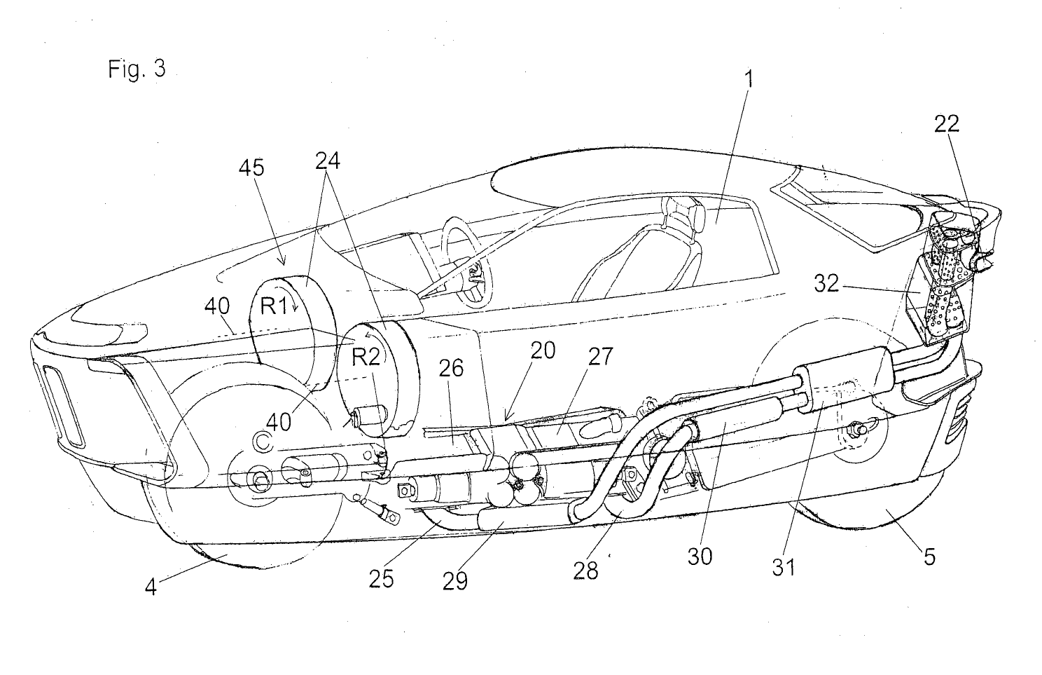

FIG. 3 shows a further perspective view, partially in section of this vehicle, in which is visible a gyroscopic system comprising two equal and counter rotating gyroscopes, and

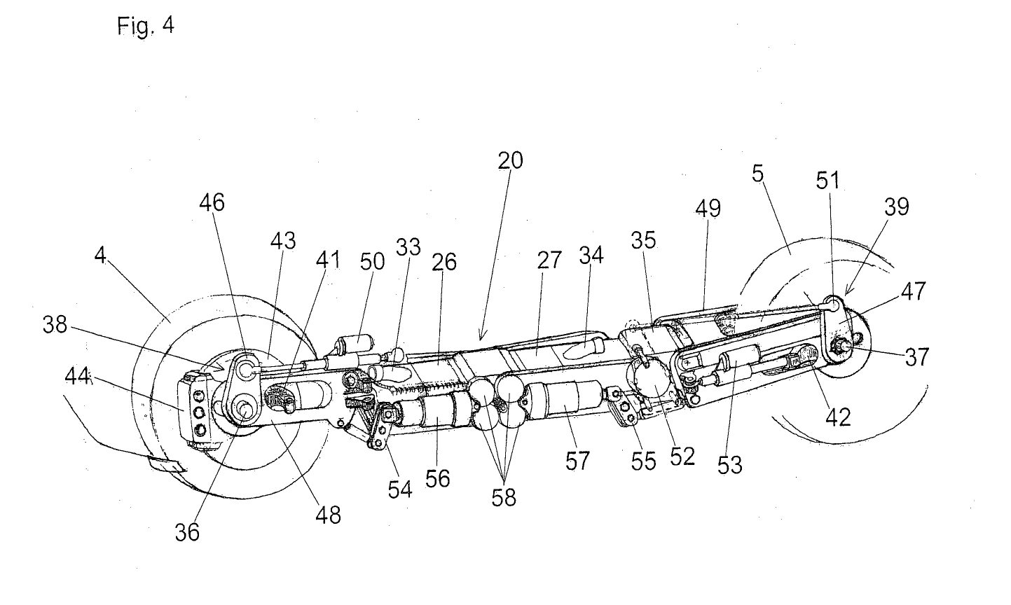

FIG. 4 shows a detailed view in perspective of the engine block of this vehicle.

With reference to these accompanying drawings and with particular reference to FIG. 1, with 1 is indicated a passenger compartment of a two-wheeled vehicle in accordance with the present invention. Such a compartment includes a seat 3 for a pilot and, optionally, a passenger seat located back to the seat 3. Inside the compartment 1 are also hosted acceleration and braking command of the vehicle, which can be pedals like in normal cars, or devices embedded in drive wheel 2. The wheel 2 includes also a commands to activate automatic or robotic transmission for this vehicle. The vehicle is equipped with a pair of main wheels, namely a front wheel 4 and a rear wheel 5. These wheels 4 and 5 are aligned, lie on a mean longitudinal plane of the vehicle and both are equipped with a fairing 6 and 7, to eliminate any adverse aerodynamic effects and limiting the efficiency of the vehicle. Such fairings 6 and 7 are respectively provided with a front and rear removable lid, see for example the removable lid 13 able to facilitate the removal of the rear wheel 5. This vehicle is equipped with a means 8 for parking, designed to act as we shall see in the description of the operation, in cases of emergency, in cases of sudden loss of adhesion and prevention in the case of hazardous road surfaces. This system 8 includes two small idler wheels 9, one on each side of the vehicle, only the wheel on the left side of the vehicle is visible in FIG. 9 and it is in a lowered position, i.e. on the ground. The not shown right wheel and the left wheel 9 are positioned symmetrically with respect to a mean longitudinal plane of the vehicle.

These wheels are normally in a fully raised position, and each includes a pair of telescopic support rods 10. By using these telescopic rods 10 each of the wheels 9 can be lowered or raised. These telescopic poles are partially enclosed within a fairing 11, which covers also a suitably shaped arm 19, shown in FIG. 2, of the parking system 8. On the front of the vehicle there are two headlights 12, of which the left one is visible in the figure. Between the two wheels 4 and 5, on the bottom of the vehicle, there is a fairing 14 that covers the motor 20 depicted in FIG. 2. The fairing 14 includes a front air intake 15 for cooling the engine and a back outlet 16 of the cooling air.

On the front fairing respect to the cockpit 1, see FIG. 2 of the accompanying drawings, is positioned a front light 17 equipped with integrated flashing arrows, whereas on the rear fairing respect to the cockpit 1 a rear light 21 is obtained, also equipped with flashing integrated arrows. The arm 19 of parking system 8 is located at the inner end around a rotation fixed pivot 18 and at the other end it supports two telescopic rods 10, that in figure are shown in the two main positions, that is dashed completely unthread, with the wheel 9 in the down position and grip, and continuous line completely curved inwards, with the wheel 9 in a raised position.

As mentioned previously on each side of the vehicle is expected a idler wheel, so on the right side of the vehicle, not visible in the figures, there will be another rotation fixed pin, another arm that supports two telescopic rods, and as said another wheel. The rotation of the two arms 19 around the fixed pins 18 and the excursion of the telescopic rods 10 is controlled by a standard electronic control unit provided for this vehicle and not shown in the figures. On the rear of the vehicle are also illustrated the terminal 22 of an exit silencer of exhaust gases from the engine and a plate 23 capable of accommodating the number plate of the vehicle.

In FIG. 3, for clarity of illustration, the parking system 8 described above is omitted. In such figure a gyroscopic system 45 is shown provided with a pair of gyrostats 24, consisting of masses, such as disks or the like, rotating at high speed and in opposite directions in the direction of the arrows R1 and R2, around their axes 40. The gyrostats 24 are equal and positioned between the front wheel 4 and the front of the passenger compartment 1 and their rotation axes 40 are parallel and directed in the longitudinal direction of the vehicle. These gyrostats 24 lie on the same transverse plane perpendicular to the longitudinal axis in which lie the two wheels 4 and 5 of the vehicle and are both connected to the electric motor generators 58, visible in FIG. 4, which put them in rotation, so ultimately they perform the function of systems for energy storage or flywheel batteries.

The two gyrostats 24 are also symmetrically arranged with respect to the median longitudinal plane in which lie the two main wheels 4 and 5. Each of these gyrostats 24 associated with the electric motors 58 might provide a very powerful gyroscopic effect: if, for example, it is assumed that each of those gyrostat has a weight of 10 kg and a diameter of 0.31 m and the rotation speed of each of them is 24,000 rpm, you can get a total gyro moment of about 214 kg*m², then a torque of 428 kg*m², more than enough to dominate even a heavy quick vehicle. The engine 20 is a twin-cylinder boxer engine with twin and coplanar crankshaft and with cross shaft. This engine 20 includes a pair of cylinders, namely a front cylinder 26 and a rear cylinder 27, provided with an exhaust manifold 25 and 28 of the flue gas, respectively downstream of which a catalyst 29 and 30 is prepared.

Both exhaust manifolds 25 and 28 of the two cylinders 26 and 27 converge in a compensator pre-silencer 31, from which the exhaust gases pass to a silencer 32 and then to the tailpipe 22.

Each of these cylinders 26 and 27, see FIG. 4 of the accompanying drawings, includes an intake pipe 33 and 34 and the engine 20 is equipped with a dual clutch 52, and at the middle are placed the four electric motor generators 58. The two-cylinder longitudinal engine 20 with twin and coplanar crankshaft is provided for the purpose of obtaining a perfect balance of the vehicle and get it for car-like roominess. The two main wheels 4 and 5 of the vehicle are fixed through their hubs 36 and 37 to a front swing arm 48 and a rear swing arm 49, respectively. Both swing arms 48 and 49 are provided with an attachment for a steering mechanism of the two wheels 4 and 5, ie the device 38 of the front wheel steering 4 and the rear wheel 5 steering device 39.

These devices 38 and 39 include steering arms 41 and 42, respectively tied to the swing arms 48 and 49 and include a stub axle inside the hub 36 and 38 of the corresponding wheels 4 and 5. The rear fork 49 includes a secondary internal drive in an oil bath. The steering device 39 of the rear wheel 5 includes an electric actuator 53 commanded and controlled by the electronic control unit. This vehicle includes two connecting rods 46 and 47 for trail control of the front 4 and rear 5 wheels. The trail of the two wheels 4 and 5 is doubly adjusted by a kinematics dependent on the inclination linkage between the suspension and chassis, ie front and rear forks 48 and 49 with their levers 54 and 55, and by means of electrical actuators 50 and 51 governed by the electronic control unit and capable of transforming the front and back trail from positive to negative. The levers 54 and 55 of the left side of the vehicle are also connected with the adjustable parameters shock absorbers 56 and 57: one of these adjustable parameters can be the height of the shock absorbers. The engine 20 is also equipped with an automatic gearbox 35, positioned on the rear fork 49. As for the braking system, illustrated as an example for the front wheel 4, it includes a double-disc 43 cooperating with a brake caliper 44. This 20 two-cylinder boxer engine is mounted between this pair of swing arms 48 and 49 and the two cylinders 26 and 27 slot each a piston with two rods, each bound to its own crankshaft, resulting in a horizontally opposed and coplanar engine. In this engine there will be therefore four shafts that engage with each other and are in pairs contrarotating. The four rods and four shafts lie on the same plane and are parallel to the mean longitudinal axis of the vehicle so as not to cause any destabilizing torque. If this vehicle is stationary, such as parking, left and right side wheels 9 of the parking system 8 are lowered. When the pilot boards and starts the vehicle, the electronic control unit starts the engine 20 and sets the appropriate speed by the motor generators 58, the two counter-gyrostats 24. At the same time the control unit controls the lifting of the side wheels of the parking system 8. Thanks to the action of the two high-speed counter gyrostats 24, started vehicle remains in balance even under static conditions, then, for example, even with a stop at a traffic light. The parking system 8 automatically will operate if the two gyrostats 24 cease to work, for example, to a complete vehicle stop, or in case of emergency, in cases of sudden loss of adhesion and prevention in the event of hazardous road surfaces.

Using the gyroscopic system 45 equipped with the two 24 gyrostats this vehicle is equipped with a convenient stability induced. The rotation axes 40 of these gyrostats, as described above, are parallel and symmetrical with respect to the longitudinal axis of the vehicle on which the wheels 4 and 5 lie. Since these are counter-gyrostat they do not give rise to destabilizing torques. Their placement at the top near the front wheel 4 is expected to exert a strong drive torque. The vehicle, which needs stability in the boot, takes advantage of the effects of inertia of 24 gyrostats because once put in rotation and in the absence of external forces tend to maintain a fixed space in the direction of their axes of rotation 40. Since these gyrostats 24 are also coplanar, they can cancel both the vibrations due to the rotation and the unplanned variations of angular momentum, this could be occur for example in the event that this vehicle strucks a hole or an obstacle on the road. In essence, the vehicle receives tilting pulses equal and opposite able to cancel each other according to a kind of induced self-balancing.

The gyroscopic effect of the two gyrostats 24, while driving the vehicle, can vary the vehicle inclination to change direction or to find the exact angle respect to the roadway. To obtain a force capable of tilting of a given angle this vehicle, you must recline at once and in alternating directions the two gyrostats 24: so you will get a boost due to the gyroscopic effect, capable of bending the vehicle of a right angle to correctly take a corner. In practice each gyrostat 24 to which a torque is applied that can tilt it returns a force of precession that is “low” in one direction of about 90° with respect to the tilting torque and this is the effect that will recline the vehicle of the required angle. You can get, thanks to the two gyrostats 24, an induced change of the bending angle.

As for the steering system of this vehicle, the electronic steering is operated in synergy with the operation of the gyroscopic system and the steering and trail control is facilitated by the electronic control unit. The electric steering actuators may be one or two for each wheel. The movements of steering the driver automatically performs on conventional motorbikes, almost unconsciously, to produce or enhance the effects necessary for driving the vehicle, are produced by the control unit that sends pulses to the actuators in synergy with gyrostats, without the need for the driver to move the steering wheel. While driving forward the rear wheel steering is not controlled by the pilot, but only by the control unit, while the trail control is exercised by the electronic unit establishing increasing values as a function of the increasing speed, adapting them to every driving situation.

1-10. (canceled)

11. A two wheeled vehicle comprising a front wheel and a rear wheel which lie on a mean longitudinal plane of the vehicle; a cockpit within which is provided at least one seat for a driver and a command steering wheel; an electronic control unit; a gyroscopic system able to provide induced stability and self-balancing of the vehicle, in both dynamic and static conditions of the vehicle, the gyroscopic system including at least two controlling gyrostats being equal, symmetrically arranged with respect to the mean longitudinal plane of the vehicle and having parallel rotation axes, the gyrostats being associated with related operation units controlled by the electronic control unit; and a parking system provided with a pair of side wheel units which allow lowering or raising of the side wheels, in which the gyrostats lie on a same plane substantially orthogonal to the mean longitudinal plane of the vehicle, the rotation axes of the gyrostats being directed in the longitudinal direction of the vehicle and the parking system being adapted to cooperate with the said gyroscopic system under the control of the said electronic control unit and operable to automatically lower the said side wheels, in emergency situations or stopping situations of the gyrostats.

12. A vehicle according to claim 11, in which the gyrostats controlled by electric motor generators controlled by the electronic control unit, such that the said gyrostats perform the function of energy storage systems or flywheel batteries.

13. A vehicle according to claim 11, in which said side wheels are arranged symmetrically with respect to the mean longitudinal plane of the vehicle and said parking system includes telescopic rods for lowering and lifting of each wheel, said telescopic rods being supported around a rotation pivot by at least one rotatable arm.

14. A vehicle according to claim 11, in which both wheels are housed inside a fairing compartment.

15. A vehicle according to claim 11, in which the said parking system is at least partially housed within a fairing compartment.
